(19) United States
(12) Patent Application Publication
(10) Pub. No.: US 2025/0343003 A1
(43) Pub. Date: Nov. 6, 2025

(54) MULTILAYER CERAMIC CAPACITOR

(71) Applicant: KYOCERA Corporation, Kyoto-shi, Kyoto (JP)

(72) Inventors: Yuta OKAZAKI, Kirishima-shi (JP); Yuka SEO, Kirishima-shi (JP); Koshiro SUGIMOTO, Aira-shi (JP); Hideyuki OSUZU, Kirishima-shi (JP)

(73) Assignee: KYOCERA Corporation, Kyoto-shi, Kyoto (JP)

(21) Appl. No.: 18/871,081

(22) PCT Filed: Jun. 1, 2023
(86) PCT No.: PCT/JP2023/020490

§ 371 Date: Dec. 2, 2024

(30) Foreign Application Priority Data
Jun. 3, 2022 (JP) 2022-091215

(51) Int. Cl. H01G 4/30; H01G 4/12

(52) U.S. Cl. CPC H01G 4/30; H01G 4/1227

(57) ABSTRACT

A multilayer ceramic capacitor includes a stack and a plurality of external electrodes. The stack includes a plurality of dielectric layers stacked on one another and a plurality of internal electrodes located along interfaces between the plurality of dielectric layers. The plurality of external electrodes is located on outer surfaces of the stack and electrically connected to the plurality of internal electrodes. The plurality of dielectric layers contains, as a main component, a perovskite compound containing Ba and Ti. Ba is partially optionally substituted with Ca, and Ti is partially optionally substituted with Zr. A sum of resistance values of the main component and other components in the plurality of dielectric layers measured with an alternating current impedance method is greater than or equal to 1 MΩ.

### TECHNICAL FIELD

The present disclosure relates to a multilayer ceramic capacitor.

### BACKGROUND OF INVENTION

A known multilayer ceramic capacitor is described in, for example, Patent Literature 1.

### CITATION LIST

### Patent Literature

Patent Literature 1: Japanese Patent No. 5757319

### SUMMARY

In an aspect of the present disclosure, a multilayer ceramic capacitor includes a stack and a plurality of external electrodes. The stack includes a plurality of dielectric layers stacked on one another and a plurality of internal electrodes located along interfaces between the plurality of dielectric layers. The plurality of external electrodes is located on outer surfaces of the stack and electrically connected to the plurality of internal electrodes. The plurality of dielectric layers contains, as a main component, a perovskite compound containing Ba and Ti. Ba is partially optionally substituted with Ca, and Ti is partially optionally substituted with Zr. A sum of resistance values of the main component and other components in the plurality of dielectric layers measured with an alternating current impedance method is greater than or equal to 1 MΩ.

In the multilayer ceramic capacitor according to an aspect of the present disclosure, the plurality of dielectric layers includes four constituents including cores being center portions of crystal grains of the main component and the other components, shells being outer peripheries of the crystal grains, grain boundaries, and interfaces between the plurality of internal electrodes and the plurality of dielectric layers. The plurality of dielectric layers is represented with an equivalent circuit model in which each of the constituents is represented by a parallel circuit including a resistance R and a capacitance C and the constituents are connected in series to one another. A sum of R1, R2, R3, and R4 is greater than or equal to 1 MΩ, where R1 is a resistance value of the cores, R2 is a resistance value of the shells, R3 is a resistance value of the grain boundaries, and R4 is a resistance value of the interfaces measured with the alternating current impedance method.

### BRIEF DESCRIPTION OF THE DRAWINGS

The objects, features, and advantages of the present disclosure will become more apparent from the following detailed description and the drawings.

FIG. 1A is a schematic cross-sectional view of a multilayer ceramic capacitor according to one or more embodiments of the present disclosure.

FIG. 1B is an enlarged view of a section 1B in FIG. 1A.

FIG. 2 is a schematic cross-sectional view of a crystal grain of a perovskite compound containing Ba and Ti in a dielectric layer included in the multilayer ceramic capacitor according to one or more embodiments of the present disclosure, illustrating its internal structure.

FIG. 3 is a diagram of a measurement device for an alternating current (AC) impedance method.

FIG. 4 is a graph showing a Cole-Cole plot of a typical multilayer ceramic capacitor.

FIG. 5 is a diagram of equivalent circuits used for analysis.

FIG. 6A is a diagram of a multilayer ceramic capacitor according to an embodiment of the present disclosure, illustrating a process in a method for manufacturing the multilayer ceramic capacitor.

FIG. 6B is a diagram of the multilayer ceramic capacitor according to the embodiment of the present disclosure, illustrating a process in the method for manufacturing the multilayer ceramic capacitor.

FIG. 6C is a diagram of the multilayer ceramic capacitor according to the embodiment of the present disclosure, illustrating a process in the method for manufacturing the multilayer ceramic capacitor.

FIG. 6D is a diagram of the multilayer ceramic capacitor according to the embodiment of the present disclosure, illustrating a process in the method for manufacturing the multilayer ceramic capacitor.

FIG. 7 is a graph showing sums of resistance values of four constituents measured with the AC impedance method shown in Table 3.

FIG. 8 is a graph showing the relationship between a resistance value R1 of cores and insulation resistance.

FIG. 9 is a graph showing the relationship between a resistance value R2 of shells and the insulation resistance.

FIG. 10 is a graph showing the relationship between a resistance value R3 of grain boundaries and the insulation resistance.

FIG. 11 is a graph showing the relationship between a resistance value R4 of interfaces between internal electrodes and dielectric layers and the insulation resistance.

FIG. 12 is a graph showing the relationship between the resistance values R1, R2, R3, and R4 and the insulation resistance.

### DESCRIPTION OF EMBODIMENTS

Recent multilayer ceramic capacitors are to be smaller and have a larger capacity. Thus, thinner dielectric layers are being developed. However, as each of the thinner dielectric layers receives a relatively higher electric field strength, multilayer ceramic capacitors are to be more reliable in receiving an applied voltage. A proposed multilayer ceramic capacitor with a known technique thus includes, for example, internal electrodes containing Ni as a main component with Sn added at a specific ratio (refer to, for example, Patent Literature 1). The multilayer ceramic capacitor has appropriate dielectric properties and is highly reliable in receiving an applied voltage with a high electric field strength.

However, the above multilayer ceramic capacitor has insufficient insulation, and is thus insufficiently reliable in receiving an applied voltage. Thus, a multilayer ceramic capacitor is to include dielectric layers with improved insulation and be more reliable in receiving an applied voltage.

A multilayer ceramic capacitor according to one or more embodiments of the present disclosure will now be described with reference to the drawings.

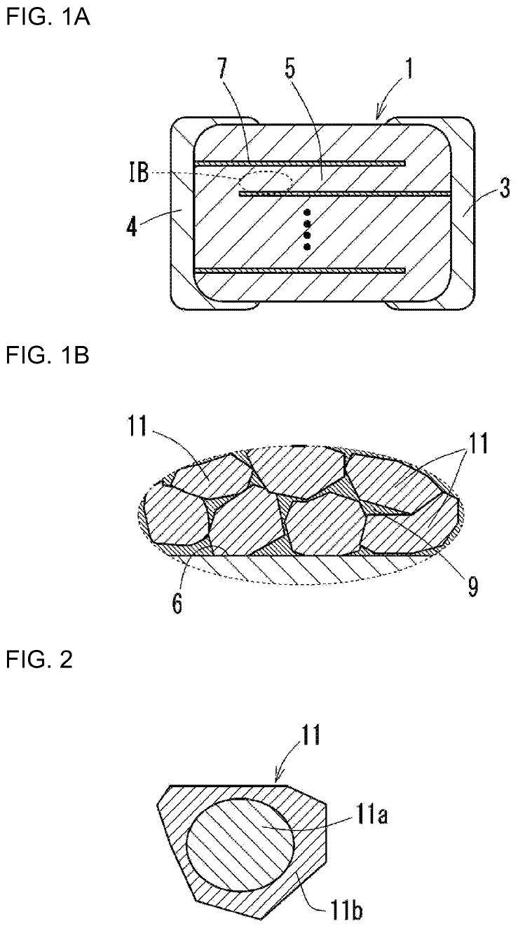

FIG. 1A is a schematic cross-sectional view of a multilayer ceramic capacitor according to one or more embodiments of the present disclosure. FIG. 1B is an enlarged view of a section 1B in FIG. 1A. In one or more embodiments of the present disclosure, the multilayer ceramic capacitor includes a capacitor body 1, and an external electrode 3 and an external electrode 4 located on two end faces of the capacitor body 1. The capacitor body 1 includes dielectric layers 5 and internal electrodes 7 alternately stacked on one another. Each of the dielectric layers 5 includes multiple crystal grains 11 of a perovskite compound containing Ba and Ti with grain boundaries 9 between the crystal grains 11.

The material for the external electrodes 3 and 4 contains, for example, Ag or Cu as a main component. Each of the internal electrodes 7 is electrically connected to the external electrode 3 or 4.

The internal electrodes 7 contain Ni as a main component. The internal electrodes 7 may or may not contain Sn. More specifically, the internal electrodes 7 may contain Sn. The Sn content may be 0.5 to 5 parts by mass to the Ni content of 100 parts by mass. When the Sn content is greater than or equal to 5 parts by mass, the internal electrodes 7 are likely to melt and have lower reliability. When the Sn content is less than or equal to 0.5 parts by mass, the internal electrodes 7 are less likely to have higher reliability.

With the internal electrodes 7 containing Sn in their raw materials as described above, Sn diffuses to the dielectric layers 5 (and partly remains in the internal electrodes 7) in a firing process during the manufacture of the multilayer ceramic capacitor. Sn diffuses at interfaces 6 between the dielectric layers 5 and the internal electrodes 7. In the internal electrodes 7, Sn migrates from their middle portions to the interfaces 6. The internal electrodes 7 thus have a greater Sn content at the interfaces 6 between the internal electrodes 7 and the dielectric layers 5 than in the middle portions in their thickness direction. The multilayer ceramic capacitor thus has a greater m value in the time-to-failure evaluation in a high-accelerated limit test (HALT) and varies less in time-to-failure. The multilayer ceramic capacitor also has a greater CR product and thus has higher reliability.

As described above, the internal electrodes 7 have a greater Sn content at the interfaces 6 between the internal electrodes 7 and the dielectric layers 5 than in the middle portions. The Sn content can be adjusted to have its peak at the interfaces 6 between the internal electrodes 7 and the dielectric layers 5 rather than inside the internal electrodes 7 by fast-firing using a heat-resistant material, or a silicon carbide (SiC) setter.

The dielectric layers 5 contain, as a main component, the perovskite compound containing Ba and Ti, with Ba partially optionally substituted with Ca and Ti partially optionally substituted with Zr.

The perovskite compound containing Ba and Ti is barium titanate (hereafter also referred to as BT), but may be perovskite barium titanate (hereafter also referred to as BCT) with Ba (A site) partially substituted with Ca. Barium titanate is expressed as BaTiO₃. Perovskite barium titanate with Ba partially substituted with Ca is expressed as (Ba₁₋ₓCax)TiO₃. In a powder of BCT described above, the amount of Ca in the A site substituted may be X=0.01 to 0.2, or specifically X=0.03 to 0.1. Perovskite barium titanate with Ti in the B-site partially substituted with Zr may also be used.

Of the above compounds, barium titanate may be used. Barium titanate has a high dielectric constant and also allows the multilayer ceramic capacitor to have high reliability.

A powder (hereafter also simply referred to as a dielectric powder) such as a BT powder and the BCT powder is synthesized by mixing compounds containing, for example, a Ba component, a Ca component, and a Ti component to have a predetermined composition. The dielectric powder such as the above powders is prepared with a synthesis method selected from, for example, liquid-phase synthesis, such as coprecipitation and an oxalate method, and hydrothermal synthesis.

The product of lattice constants a, b, and c of a dielectric is greater than or equal to 0.0653 nm³ when prepared with the oxalate method, and less than or equal to ^{0.0652 nm}³ when prepared by solid-phase synthesis. To measure the lattice constants a, b, and c, a dielectric ceramic is measured using X-ray diffraction with 2θ being 10 to 80 degrees and analyzed with a Rietveld refinement method for the crystal structure.

The particle size distribution of the dielectric powder such as the BT powder and the BCT powder may be 0.05 to 0.1 μm to allow the dielectric layers 5 to be easily thinner and increase the relative dielectric constant of the dielectric powder.

The dielectric powder such as the BT powder and the BCT powder is typically covered with, on its surfaces, additives such as MgO, an oxide of a rare earth element, and MnO. The additives covering the surfaces mix with one another to be a solid solution.

Magnesium (Mg) covering the surfaces of the dielectric powder can improve the insulation of the dielectric powder and reduce, when other additives are added later, the likelihood that the other additives mix with one another to be a solid solution. Manganese (Mn) can also improve the insulation, but can particularly increase the reduction resistance.

The rare earth element can also improve the insulation of barium titanate, but can improve the relative dielectric constant and stabilize the thermal properties of the relative dielectric constant as well. In particular, when used to cover the BT powder, the rare earth can easily form a layer on the surfaces of the BT powder.

The amount of Mg added may be 0.5 to 1 mol % when calculated as oxide to 100 mol % of the dielectric powder such as the BCT powder or the BT powder. The amount of Mn added may be 0.2 to 0.5 mol % when calculated as oxide to 100 mol % of the dielectric powder such as the BCT powder or the BT powder.

The amount of rare earth element added may be 0.5 to 3 mol % when calculated as oxide to 100 mol % of the dielectric powder such as the BT powder or the BCT powder. The rare earth element may be at least one selected from the group consisting of, for example, Y, dysprosium (Dy), Yb, and Tb.

A sintering aid added to the dielectric powder such as the BT powder or the BCT powder may be sol-gel glass with the composition of BaO:CaO:SiO₂₌25 to 35:45 to 55:15 to 25.

With the internal electrodes 7 containing Sn in their raw materials, Sn in the internal electrodes 7 diffuses to the dielectric layers 5 in the firing process, causing the dielectric layers 5 to contain Sn. The dielectric layers 5 may contain 0.03 to 3.0 parts by mass of Sn to 100 parts by mass of BT. This can improve the insulation of the dielectric layers 5, allowing the multilayer ceramic capacitor to be more reliable in receiving an applied voltage. SnO is weighed and added to the raw materials of the internal electrodes to cause the resulting multilayer ceramic capacitor to include the internal electrodes and the dielectric layers 5 each containing an amount of Sn specified in Table 1 described later.

As described above, examples of the other components in “the main component and other components included in the dielectric layers 5” include MgO, an oxide of a rare earth element, MnO, BaO, CaO, SiO₂, and SnO₂.

In one or more embodiments of the present disclosure, the sum of resistance values of the main component and the other components contained in the dielectric layers 5 measured with an alternating current (AC) impedance method is greater than or equal to 1 MΩ. This can improve the insulation of the dielectric layers 5, allowing the multilayer ceramic capacitor to be more reliable in receiving an applied voltage.

The dielectric layers 5 may include four constituents including cores, shells, grain boundaries, and the interfaces 6 between the internal electrodes 7 and the dielectric layers 5. The cores are center portions of the crystal grains of the main component and the other components of the perovskite compound. The shells are outer peripheries of the crystal grains. The dielectric layers 5 may include, for example, pores. Thus, all resistance values in the dielectric layers 5 may not be measured by simply measuring resistance values of their components. Thus, a resistance value may be measured for each of the four constituent described above.

In other words, in one embodiment of the present disclosure, the dielectric layers 5 include four constituents including cores being the center portions of the crystal grains of the main component and the other components, shells being the outer peripheries of the crystal grains, the grain boundaries, and the interfaces 6 between the internal electrodes 7 and the dielectric layers 5. The dielectric layers 5 are represented with an equivalent circuit model in which each of the constituents is represented by a parallel circuit including a resistance R and a capacitance C and the constituents are connected in series to one another. A sum of R1, R2, R3, and R4 is greater than or equal to 1 MΩ, where R1 is a resistance value of the cores, R2 is a resistance value of the shells, R3 is a resistance value of the grain boundaries, and R4 is a resistance value of the interfaces 6 measured with the AC impedance method. The sum may be greater than or equal to 3 MΩ, or more specifically, greater than or equal to 5 MΩ. This can improve the insulation of the dielectric layers 5, allowing the multilayer ceramic capacitor to be more reliable in receiving an applied voltage.

BT is hereafter used as a typical example of the perovskite compound containing Ba and Ti.

FIG. 2 is a schematic cross-sectional view of one of the BT crystal grains in the dielectric layers 5 included in the multilayer ceramic capacitor according to one or more embodiments of the present disclosure, illustrating its internal structure. In one or more embodiments of the present disclosure, each of the BT crystal grains 11 in the dielectric layers 5 in the multilayer ceramic capacitor has a core-shell structure including a core 11a and a shell 11b surrounding the core 11a. The shell is the outer periphery of the BT crystal grain after firing, and has a higher concentration of the rare earth oxide and MgO than the core. As illustrated in FIG. 1B, each of the dielectric layers 5 includes the multiple BT crystal grains 11 with the grain boundaries 9 between the BT crystal grains 11.

The BT crystal grains 11 in the dielectric layers 5 may have a mean particle diameter of 0.001 to 0.2 μm. When the mean particle diameter is greater than or equal to 0.01 μm, the BT crystal grains 11 can have a clear core-shell structure. Thus, each of the core 11a and the shell 11b can have a clearer area, allowing the dielectric layers 5 to have a high dielectric constant and high insulation.

When the mean particle diameter of the BT crystal grains 11 is less than or equal to 0.1 μm, the thinner dielectric layers 5 can be sintered with many grain boundaries 9 between the dielectric layers 5 and thus have high insulation.

Measurement with the AC impedance method is performed as described below.

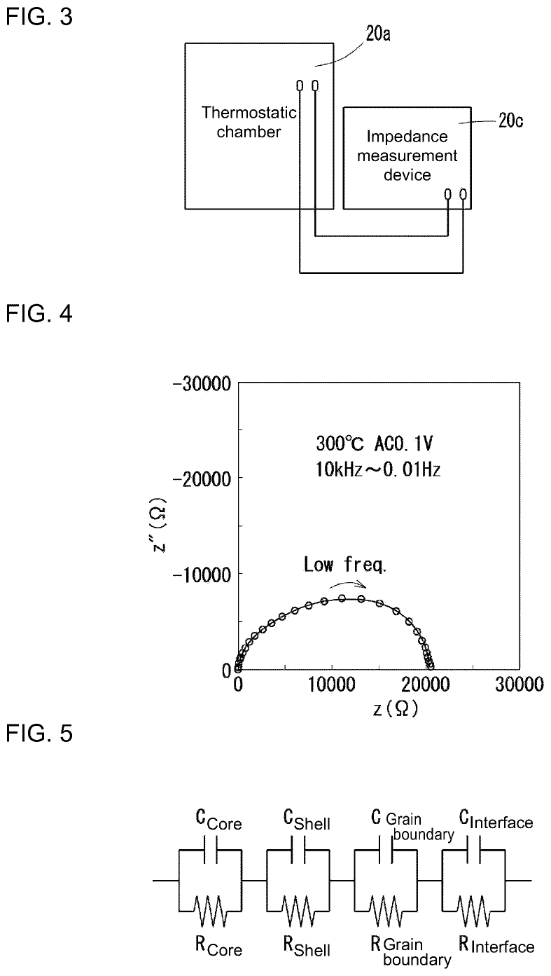

FIG. 3 is a diagram of a measurement device for the AC impedance method. In FIG. 3, a thermostatic chamber 20a controls the temperature of the multilayer ceramic capacitor placed in the thermostatic chamber as a sample. An impedance measurement device 20c includes an AC power supply.

FIG. 4 is a graph showing a Cole-Cole plot of a typical multilayer ceramic capacitor. In the present embodiment, the same or similar graphs (Cole-Cole plots) show changes in impedance at the cores (center portions) of the crystal grains of the main component and the other components of the perovskite compound, at the shells (outer peripheries), at the grain boundaries, and at the interfaces 6 between the internal electrodes 7 and the dielectric layers 5 in response to changes in measurement frequency. In this evaluation, as illustrated by equivalent circuits in FIG. 5, the dielectric layers 5 include the four constituents including the cores (center portions), the shells (outer peripheries), the grain boundaries, and the interfaces 6 between the internal electrodes 7 and the dielectric layers 5. In the graph, a horizontal axis indicates the real part of an impedance signal, and a vertical axis indicates the imaginary part of the impedance signal.

The Cole-Cole plot in FIG. 4 can be obtained for each of the four constituents including the cores (center portions), the shells (outer peripheries), the grain boundaries, and the interfaces 6 between the internal electrodes 7 and the dielectric layers 5 using dedicated software.

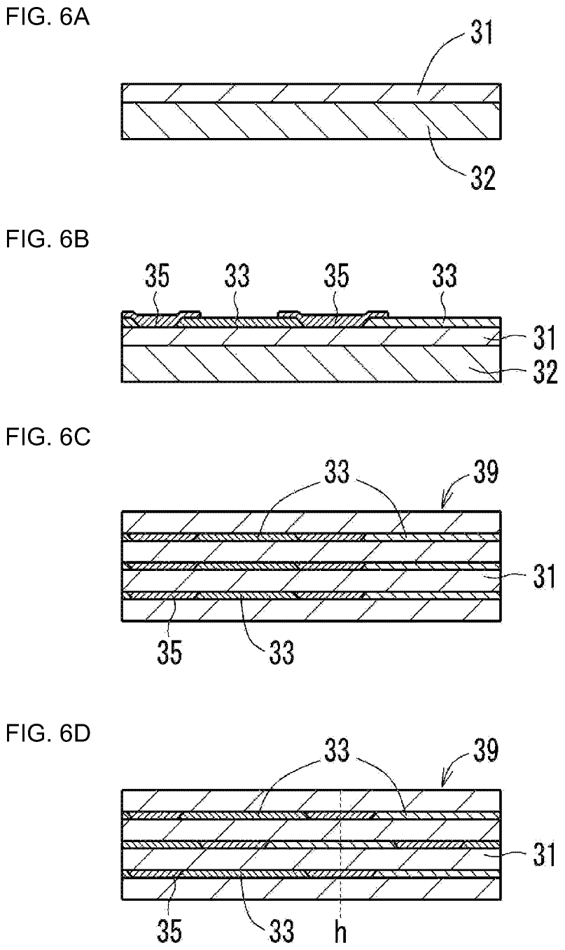

A method for manufacturing the multilayer ceramic capacitor according to the present embodiment will now be described in detail. FIGS. 6A to 6D are diagrams of the multilayer ceramic capacitor according to the embodiment of the present disclosure, illustrating processes in the method for manufacturing the multilayer ceramic capacitor.

Process (a): A dielectric powder as a raw material powder described below is mixed with an organic resin such as a polyvinyl butyral resin and a solvent such as toluene and alcohol using, for example, a ball mill to prepare ceramic slurry. The ceramic slurry is then shaped into a ceramic green sheet 31 with a sheet forming method such as doctor blading or die coating. The ceramic green sheet 31 may have a thickness of 1 to 3 μm to allow the dielectric layers 5 to be thinner and have higher insulation for achieving higher capacitance.

Process (b): A rectangular internal electrode pattern 33 is then printed on a main surface of the obtained ceramic green sheet 31. A conductor paste to be the internal electrode pattern 33 is prepared by mixing Ni or an alloy powder of Ni as a main metal component with a ceramic powder as a common material, and adding an organic binder, a solvent, and a dispersant to the mixture.

The internal electrode pattern 33 may have a thickness less than or equal to 1 μm to allow the multilayer ceramic capacitor to be smaller and include less steps caused by the internal electrode pattern 33.

To eliminate the steps caused by the internal electrode pattern 33 on the ceramic green sheet 31, a ceramic pattern 35 may be formed around the internal electrode pattern 33 with substantially the same thickness as the internal electrode pattern 33. The dielectric powder used for the ceramic green sheet 31 may be used as a ceramic component of the ceramic pattern 35 to have the same firing shrinkage as the ceramic green sheet 31 when fired together.

Process (c): An intended number of ceramic green sheets 31 each with the internal electrode pattern 33 are stacked on one another. Multiple ceramic green sheets 31 without internal electrode pattern 33 are then stacked on the top and the bottom of the above stack to form a temporary stack with the same number of the ceramic green sheets 31 without internal electrode pattern 33 on the top and the bottom. Internal electrode patterns 33 in the temporary stack deviate from one another by half in a longitudinal direction. This stacking method allows the internal electrode patterns 33 to be alternately exposed on end faces of the stack after cutting.

In addition to the above method in which the internal electrode pattern 33 is preformed on the main surface of each of the ceramic green sheets 31 before stacking, the temporary stack may be formed with another method. In the method, the internal electrode pattern 33 is printed and dried on one of the ceramic green sheets 31 that is temporarily bonded to a lower layer substrate. Another of the ceramic green sheets 31 without the internal electrode pattern 33 is then placed on and temporarily bonded to the printed and dried internal electrode pattern 33. In this manner, bonding of the ceramic green sheets 31 and printing of the internal electrode patterns 33 are performed consecutively.

Process (d): The temporary stack is then pressed at a higher temperature under a higher pressure than during the above temporary stacking to form a stack 39 in which the ceramic green sheets 31 and the internal electrode patterns 33 are firmly bonded to one another. The stack 39 is then cut along a cut line h, or in other words, substantially at the middle of the ceramic pattern 35 formed in the stack 39 in a direction perpendicular to the longitudinal direction of the internal electrode patterns 33 and in a direction parallel to the longitudinal direction of the internal electrode patterns 33 to obtain a molded capacitor body with ends of the internal electrode patterns 33 exposed. In contrast, the internal electrode patterns 33 are unexposed on a side margin of the molded capacitor body.

The molded capacitor body is then fired at a predetermined temperature in a predetermined atmosphere to form the capacitor body. In some cases, edges of the capacitor body may be chamfered, and the capacitor body may be barrel-polished to expose the internal electrodes 7 from the opposite end faces of the capacitor body 1. In the manufacturing method in the present embodiment, degreasing may be performed in a temperature range of up to 500° C. with the temperature increasing rate being 5 to 20° C./h. Firing may be performed in a hydrogen-nitrogen atmosphere with the maximum temperature range being 1000 to 1250° C. and the temperature increasing rate from the temperature at degreasing to the maximum temperature being 200 to 500° C./h. The maximum temperature may be maintained for 0.5 to 4 hours, with the temperature decreasing rate from the maximum temperature to 1000° C. being 200 to 500° C./h. Heat treatment (reoxidizing) after firing may be performed in a nitrogen atmosphere with the maximum temperature being 900 to 1100° C./h.

An external electrode paste is then applied to opposite ends of the capacitor body 1 and fired to form the external electrodes 3 and 4. Surfaces of the external electrodes 3 and 4 are plated to improve mountability.

### Working Example

Although one or more embodiments of the present disclosure will be described further using a working example, the embodiments are not limited to this working example.

A multilayer ceramic capacitor was obtained in the manner described below. The BT powder (BaTiO₃) was used as the dielectric powder. As shown in the dielectric layer 5 section in Table 1, the surfaces of the BT powder were covered with MnO, MgO, and DyO at the ratios of 0.2 mol % of Mn, 1.5 mol % of Mg, and 1.5 mol % of Dy as well as 0.8 parts by mass of glass to 100 parts by mass of MnMgDy by liquid-phase synthesis. The MnO, MgO, DyO, and glass were then heated at a temperature less than or equal to 500° C. to adhere to the BT powder.

A mixed solvent of toluene and alcohol as a solvent was added to and wet-blended with the above dielectric powder using zirconia balls with a diameter of 5 mm. A polyvinyl butyral resin and a mixed solvent of toluene and alcohol were then added to and wet-blended with the wet-blended dielectric powder using zirconia balls with a diameter of 5 mm again to prepare ceramic slurry. A ceramic green sheet with a thickness of 2.5 μm was then obtained by doctor blading.

Multiple rectangular internal electrode patterns containing Ni as a main component were then printed on the upper surface of the ceramic green sheet. A conductor paste used for the internal electrode patterns contained a Ni powder with a mean particle diameter of 0.3 μm.

Subsequently, 100 ceramic green sheets with the internal electrode patterns printed were stacked on one another, and 20 ceramic green sheets without the internal electrode patterns were stacked on each of the upper and lower surfaces of the 100 ceramic green sheets. The stacked ceramic green sheets were then collectively pressed using a press at a temperature of 60° C. under a pressure of 10⁷ Pa for ten minutes, and cut into a predetermined size.

The resultant stack was debound at 300° C./h in the atmosphere with the temperature increasing rate being 10° C./h, and then fired at 1040 to 1200° C. for two hours in a hydrogen- nitrogen atmosphere with the temperature increasing rate from 500° C. being 300° C./h. Subsequently, the stack was cooled to 1000° C. with the temperature decreasing rate being 300° C./h, reoxidized at 1000° C. in a nitrogen atmosphere for four hours, and cooled with the temperature decreasing rate being 300° C./h to obtain the capacitor body. The capacitor body had the dimensions of 1×0.5×0.5 mm³ with each of the dielectric layers 5 having a thickness of 1.8 μm.

After the fired capacitor body was barrel-polished, an external electrode paste containing a Cu powder and glass was applied to two ends of the capacitor body and baked at 850° C. to form the external electrodes 3 and 4. The surfaces of the external electrodes 3 and 4 were then plated with Ni and Sn in this order using an electrolytic barrel machine to obtain the multilayer ceramic capacitor.

As shown in Table 1, in manufacturing the above multilayer ceramic capacitor, different samples including the dielectric layers 5 with the same composition were manufactured. Samples Nos. 1 to 6 contain different amounts of Sn in the internal electrodes 7. Sample No. 7 contains the BT powder with a grain size of 70 mm instead of 50 mm. Samples Nos. 8 and 9 contain the BT powder that was prepared by solid-phase synthesis instead of the oxalate method.

For each of the samples in the working example shown in Table 1, SnO is weighed and added to the raw materials of the internal electrodes to cause the resulting multilayer ceramic capacitor to include the internal electrodes and the dielectric layers 5 each containing an amount of Sn specified in Table 1. Each of the obtained samples contained components corresponding to the table.

Table 2 shows the insulation resistance (IR), the capacitance (Cap), the product (CR) of the insulation resistance and the capacitance, the insulation breakdown voltage (BVD), the Weibull modulus (m value), and the mean time to failure (MTTF) for each of the sample multilayer ceramic capacitors.

TABLE 1

| | | | Dielectric layer | | | | | | | |
|---|---|---|---|---|---|---|---|---|---|---|
| | | | | | | | | Glass | | |
| | | | | | | | | (part by | | |
| | Internal | | | | | | | mass to | | |
| | electrode | | | | | | | 100 parts | BT | BT |
| | Ni | Sn | | | | | Sn (part | by mass | powder | powder |
| | (part by | (part by | BT | | | | by | of | grain | preparing |
| | mass | mass/Ni) | (mol %) | Mn | Mg | Dy | mass/BT) | MnMgDy) | size | method |
| Sample | 100 | 0 | 100 | 0.2 | 1.5 | 1.5 | 0 | 0.8 | 50 nm | Oxalate |
| No. 1 | | | | | | | | | | method |
| Sample | 100 | 0.5 | 100 | 0.2 | 1.5 | 1.5 | 0.03 | 0.8 | 50 nm | Oxalate |
| No. 2 | | | | | | | | | | method |
| Sample | 100 | 1 | 100 | 0.2 | 1.5 | 1.5 | 0.10 | 0.8 | 50 nm | Oxalate |
| No. 3 | | | | | | | | | | method |
| Sample | 100 | 2 | 100 | 0.2 | 1.5 | 1.5 | 1.00 | 0.8 | 50 nm | Oxalate |
| No. 4 | | | | | | | | | | method |
| Sample | 100 | 4 | 100 | 0.2 | 1.5 | 1.5 | 2.00 | 0.8 | 50 nm | Oxalate |
| No. 5 | | | | | | | | | | method |
| Sample | 100 | 5 | 100 | 0.2 | 1.5 | 1.5 | 3.00 | 0.8 | 50 nm | Oxalate |
| No. 6 | | | | | | | | | | method |
| Sample | 100 | 0 | 100 | 0.2 | 1.5 | 1.5 | | 0.8 | 70 nm | Oxalate |
| No. 7 | | | | | | | | | | method |
| Sample | 100 | 0 | 100 | 0.2 | 1.5 | 1.5 | 0 | 0.8 | 50 nm | Solid- |
| No. 8 | | | | | | | | | | phase |
| | | | | | | | | | | synthesis |
| Sample | 100 | 2 | 100 | 0.2 | 1.5 | 1.5 | 1 | 0.8 | 50 nm | Solid- |
| No. 9 | | | | | | | | | | phase |
| | | | | | | | | | | synthesis |

TABLE 2

| | IR | Cap | CR | | m value in | |
|---|---|---|---|---|---|---|
| | (MΩ) | (uF) | product | BDV | S-HALT | MTTF |
| Sample | 8012 | 0.862 | 6906 | 66 | 1.9 | 25.6 |
| No. 1 | | | | | | |
| Sample | 8265 | 0.859 | 7100 | 67 | 4.5 | 48.2 |
| No. 2 | | | | | | |
| Sample | 8477 | 0.847 | 7180 | 69 | 4.8 | 50.1 |
| No. 3 | | | | | | |
| Sample | 8364 | 0.832 | 6959 | 66 | 4.2 | 49.8 |
| No. 4 | | | | | | |
| Sample | 7492 | 0.783 | 5866 | 55 | 3.3 | 31.5 |
| No. 5 | | | | | | |
| Sample | 6469 | 0.776 | 5020 | 48 | 1.7 | 23.7 |
| No. 6 | | | | | | |
| Sample | 5322 | 0.872 | 4641 | 54 | 1.8 | 21.8 |
| No. 7 | | | | | | |
| Sample | 2018 | 0.948 | 1913 | 43 | 1.6 | 17.4 |
| No. 8 | | | | | | |
| Sample | 2174 | 0.954 | 2074 | 49 | 3.5 | 33.0 |
| No. 9 | | | | | | |

IR: The IR was measured based on the measurement method defined in JIS C 5101-1 using an insulation resistance meter R8340A (Advantest Corporation).
Cap: The Cap was measured using an LCR meter 4284A (YHP) at 25° C. and a frequency of 1.0 kHz with a measurement voltage of 0.5 Vrms.
CR product: The CR product is the product of the IR and Cap.
BDV: The BDV was measured in silicone oil using a withstand voltage tester (Kikusui Electronics Co., Ltd.).

Weibull modulus (m value) and MTTF: A HALT was performed. More specifically, for each of the above samples, 20 multilayer ceramic capacitors continuously received an applied voltage of 10 V and were determined to have a failure when the insulation resistance became 0 Ω. The MTTF and the time-to-failure variation (Weibull modulus, or m value) was determined using Weibull plots. A greater value of MTTF indicates a longer service life.

Mean particle diameter: The mean particle diameter of the BT powder was determined using a scanning electron microscopy (SEM). After a polished surface was etched, 20 crystal grains in an electron micrograph were selected. The maximum diameters of the 20 crystal grains were determined by intercepting to determine the mean value.

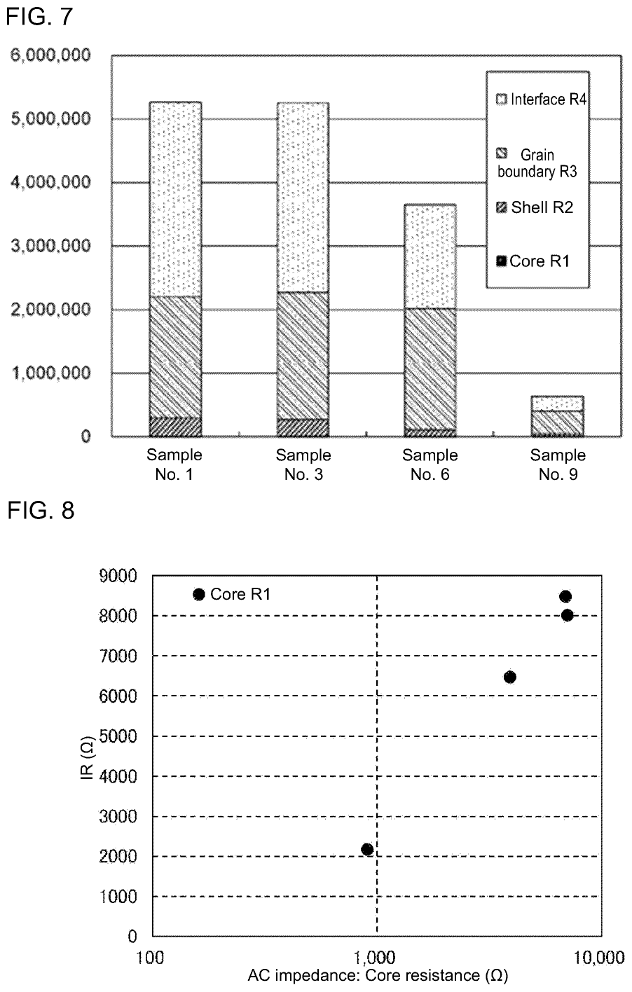

For samples Nos. 1, 3, 6, and 9 of samples Nos. 1 to 9, the resistance values of four constituents including the cores (center portions), the shells (outer peripheries), the grain boundaries, and the interfaces 6 between the internal electrodes 7 and the dielectric layers 5, and the sum of their resistance values were determined with the AC impedance method. Table 3 shows the results. FIG. 7 shows the results in a graph. FIG. 7 is a graph showing sums of the resistance values of the four constituents measured with the AC impedance method shown in Table 3.

TABLE 3

| | AC impedance (Cole-Cole) | | | | Sum of R1, |
|---|---|---|---|---|---|
| | Core | Shell | Grain | Interface | R2, R3, and |
| | R1 | R2 | boundary R3 | R4 | R4 |
| Sample | 7,028 | 291,900 | 1,908,700 | 3,061,100 | 5,268,728 |
| No. 1 | | | | | |
| Sample | 6,896 | 264,850 | 1,999,300 | 2,989,200 | 5,260,246 |
| No. 3 | | | | | |
| Sample | 3,901 | 109,330 | 1,905,200 | 1,639,300 | 3,657,731 |
| No. 6 | | | | | |
| Sample | 902 | 43,590 | 358,380 | 238,540 | 641,412 |
| No. 9 | | | | | |

Based on the results in Table 3, the relationships between the resistance values of the four constituents and the IR were shown in graphs. The resistance values of the four constituents include the resistance value R1 of the cores (center portions), the resistance value R2 of the shells (outer peripheries), the resistance value R3 of the grain boundaries, and the resistance value R4 of the interfaces 6 between the internal electrodes 7 and the dielectric layers 5.

FIG. 8 is a graph showing the relationship between the resistance value R1 of the cores and the IR.

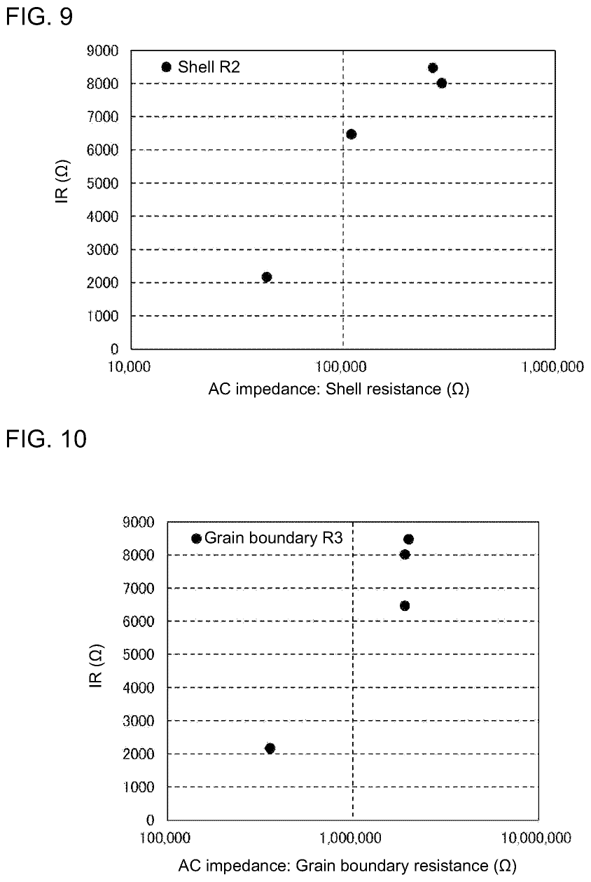

FIG. 9 is a graph showing the relationship between the resistance value R2 of the shells and the IR.

FIG. 10 is a graph showing the relationship between the resistance value R3 of the grain boundaries and the IR.

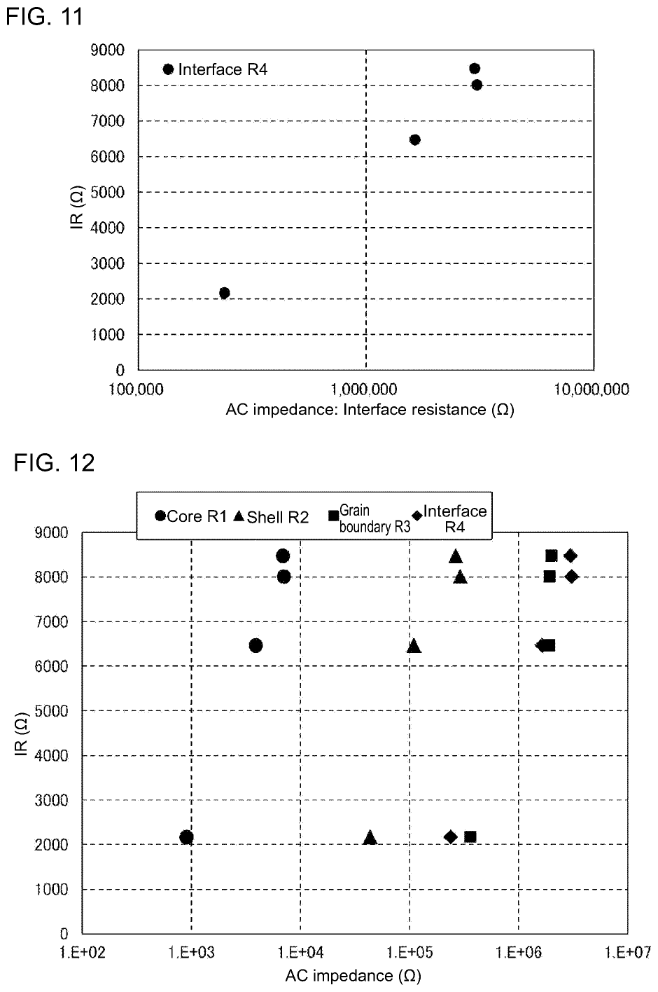

FIG. 11 is a graph showing the relationship between the resistance value R4 of the interfaces 6 between the internal electrodes 7 and the dielectric layers 5 and the IR.

FIG. 12 is a graph showing the relationship between the resistance values R1, R2, R3, and R4 and the IR.

In each of the graphs, the resistance value and the IR are proportional to each other.

In samples Nos. 1, 3, and 6, the sum of the resistance values of the four constituents in the dielectric layers 5 measured with the AC impedance method is greater than three million ohms and is thus greater than or equal to 1 MΩ. The multilayer ceramic capacitor in each of samples Nos. 1, 3, and 6 thus has a high IR, a high BDV, and appropriate reliability.

In sample No. 9, the sum of the resistance values of the four constituents in the dielectric layers 5 measured with the AC impedance method is less than one million ohms and is thus not greater than or equal to 1 MΩ. The multilayer ceramic capacitor in sample No. 9 thus has a low IR, a low BDV, and lower reliability.

In Table 3, R2 (the resistance value of the shells being the outer peripheries of the BT crystal grains) in each of samples Nos. 1 and 3 is greater than or equal to 200000 Ω, indicating a greater thickness of the shells. This increases the IR of the multilayer ceramic capacitor to greater than or equal to 8000 MΩ, further improving the reliability.

Sn contained in the internal electrodes 7 diffuses to the dielectric layers 5 during the firing process, causing the dielectric layers 5 to contain 0.5 to 5 parts by mass of Sn (in sample Nos. 2, 3, 4, and 6). This allows the multilayer ceramic capacitor to have the IR greater than or equal to 6000 MΩ, improving the reliability. In the multilayer ceramic capacitor in sample No. 9, the internal electrodes 7 contain 2 parts by mass of Sn as in sample No. 4. However, the sum of the resistance values of the constituents in the dielectric layers 5 measured by the AC impedance method is less than 1 MΩ, and the IR of the multilayer ceramic capacitor is 2174 Ω. With the IR much lower, the multilayer ceramic capacitor in sample No. 9 is thus less reliable than in sample No. 4 in which the sum of the resistance values of the four constituents in the dielectric layers 5 measured with the AC impedance method is greater than or equal to 1 MΩ.

The quantitative analysis of Sn was performed in the manner described below.

Three internal electrodes 7 were randomly selected and cut out from a single multilayer ceramic capacitor by focused ion beam (FIB) processing to obtain three thin samples. A mean value of 30 positions (10 positions×3 samples) at the interfaces 6 between the internal electrodes 7 and the dielectric layers 5 was determined. A mean value of 30 positions (10 positions×3 samples) in the middle portions of the internal electrodes was determined. The quantitative analysis of Sn was performed with a transmission electron microscope (TEM) to compare the results. The Sn content was determined using a mean value of each of the above 30 positions (10 positions×3samples).

In each of samples Nos. 2, 3, 4, and 5, the internal electrodes 7 contain Sn. Sn diffuses at the interfaces 6 between the dielectric layers 5 and the internal electrodes 7. In the internal electrodes 7, Sn migrates from their middle portions to the interfaces 6. Thus, the internal electrodes 7 have a greater Sn content at the interfaces 6 between the internal electrodes 7 and the dielectric layers 5 than in the middle portions.

The multilayer ceramic capacitor thus has a greater m value and a greater MTTF value in the time-to-failure evaluation in a HALT and varies less in time-to-failure. The multilayer ceramic capacitor also has a greater CR product and thus has higher reliability.

For samples Nos. 2, 3, 4, and 5, the Sn content of the internal electrodes 7 increases from 0.5 to 4 parts by mass in the order of samples Nos. 2, 3, 4, and 5. However, each of the m value, the MTTF, the IR, the Cap, the CR product, and the BDV of the multilayer ceramic capacitor is the greatest when the Sn content is 1 part by mass, and then slightly decreases and does not increase as the Sn content increases. This indicates that the internal electrodes 7 have a greater Sn content at portions adjacent to the dielectric layers 5 when Sn diffuses from the portions of the internal electrodes 7 adjacent to the dielectric layers 5 to the interfaces 6 at the dielectric layers 5. More specifically, the internal electrodes 7 have a greater Sn content at the interfaces 6 than in the middle portions.

The quantitative analysis of Sn was performed in the manner described below.

The Sn content in the middle portions and the Sn content in end portions of the internal electrodes 7 are measured by randomly selecting three internal electrodes 7 from a single multilayer ceramic capacitor, cutting out the three internal electrodes 7 by FIB processing into three thin samples, dividing the three samples into three middle samples and three end samples, and performing the quantitative analysis of Sn with a TEM at ten randomly selected positions in each of the sample.

In the above experimental examples, the multilayer ceramic capacitor has a higher IR, greatly improving the reliability, when the dielectric layers 5 in one or more embodiment of the present disclosure have a resistance value greater than or equal to 1 MΩ. In the multilayer ceramic capacitor according to one or more embodiments of the present disclosure, the dielectric layers 5 contain the perovskite compound containing Ba and Ti as a main component (Ba may be partially substituted with Ca and Ti may be partially substituted with Zr). The sum of the resistance values of the main component and the other components in the dielectric layers 5 measured with the AC impedance method is greater than or equal to 1 MΩ. As described above, this results from the dielectric layers made of the barium titanate powder prepared with the oxalate method. The dielectric layers in one or more embodiments of the present disclosure are obtained by adding the additives shown in Table 1 to the barium titanate powder prepared with the oxalate method and firing the resultant barium titanate powder.

When the lattice constants a, b, and c of the crystal grains of barium titanate in the dielectric layers in one or more embodiments of the present disclosure are measured by X-ray diffraction, the volume V of each unit cell expressed by the product of the lattice constants a, b, and c is greater than or equal to 0.0653 nm³ and less than or equal to 0.0657 nm³. The volume V per unit cell expressed by the product of the lattice constants a, b, and c of the barium titanate powder prepared with the oxalate method is greater than the volume V per unit cell expressed by the product of the lattice constants a, b, and c of the crystal grains of the barium titanate powder prepared with the solid-phase method. As described above, the dielectric layers made of the barium titanate powder prepared with the oxalate method have greater lattice constants. Thus, Mg, Mn, and Dy as the additives shown in Table 1 can easily partially mix with barium titanate to be a solid solution. This may improve the IR of the dielectric layers and the AC impedance of the multilayer ceramic capacitor. In this case, the barium titanate powder prepared with the oxalate method may have a mean particle diameter less than or equal to 50 nm. When the barium titanate powder prepared with the oxalate method has a mean particle diameter exceeding the above range, the IR is likely to be lower. For example, in sample No. 7, the barium titanate powder prepared with the oxalate method has a mean particle size of 70 nm. Thus, the IR of sample No. 7 is lower than the IRs of samples Nos. 1 to 6 in which the barium titanate powder prepared with the oxalate method has a mean particle diameter of 50 nm.

Each of the samples Nos. 1 to 6 has an AC impedance much higher than the AC impedance of each of the multilayer ceramic capacitor in sample Nos. 8 and 9 including the dielectric layers of the barium titanate powder prepared by solid-phase synthesis with the same mean particle diameter of 50 nm. This may be due to, as described above, the product of the lattice constants of barium titanate in the dielectric layers in each of samples Nos. 1 to 6 being greater than the product of the lattice constants of barium titanate in the dielectric layers in each of samples Nos. 8 and 9.

Among these samples, the AC impedance value R3 of the grain boundaries in sample No. 3 (in which 0.1 part by mass of Sn was added) was greater than in sample No. 1 (in which 0 part by mass of Sn was added). With the IR of sample No. 3 higher than the IR of sample No. 1, an increase in the AC impedance value R3 caused by adding a predetermined amount of Sn may cause an increase in the IR.

Additionally, in sample No. 6 (in which 3 parts by mass of Sn was added), the decrease in the AC impedance value R4 of the interfaces was greater than the decrease in the AC impedance value R3 of the grain boundaries in the AC impedance measurement. Thus, in sample No. 6, the AC impedance value R3 of the grain boundaries was greater than the AC impedance value R4 of the interfaces. In sample No. 6, a decrease in the AC impedance at the interfaces may be associated with a decrease in the IR. Thus, as in sample No. 3, the IR of the multilayer ceramic capacitor containing a predetermined amount of Sn is further increased together with its AC impedance when the impedance values are greater in the order of the cores, the shells, the grain boundaries, and the interfaces, and the AC impedance value R3 of the grain boundaries is greater than in the multilayer ceramic capacitor containing no Sn.

In one or more embodiments of the present disclosure, the multilayer ceramic capacitor includes the dielectric layers with improved insulation and is thus more reliable in receiving an applied voltage.

A multilayer ceramic capacitor according to one or more embodiments of the present disclosure may have aspects (1) to (5) described below.

(1) A multilayer ceramic capacitor, comprising:
a stack including a plurality of dielectric layers stacked on one another and a plurality of internal electrodes located along interfaces between the plurality of dielectric layers; and
a plurality of external electrodes located on outer surfaces of the stack and electrically connected to the plurality of internal electrodes,
wherein the plurality of dielectric layers comprises, as a main component, a perovskite compound containing Ba and Ti, Ba is partially optionally substituted with Ca, and Ti is partially optionally substituted with Zr, and
a sum of resistance values of the main component and other components in the plurality of dielectric layers measured with an alternating current impedance method is greater than or equal to 1 MΩ.

(2) The multilayer ceramic capacitor according to (1), wherein
the plurality of dielectric layers includes four constituents including cores being center portions of crystal grains of the main component and the other components, shells being outer peripheries of the crystal grains, grain boundaries, and interfaces between the plurality of internal electrodes and the plurality of dielectric layers, and the plurality of dielectric layers is represented with an equivalent circuit model in which each of the constituents is represented by a parallel circuit including a resistance R and a capacitance C and the constituents are connected in series to one another, and
a sum of R1, R2, R3, and R4 is greater than or equal to 1 MΩ, where R1 is a resistance value of the cores, R2 is a resistance value of the shells, R3 is a resistance value of the grain boundaries, and R4 is a resistance value of the interfaces measured with the alternating current impedance method.

(3) The multilayer ceramic capacitor according to (1) or (2), wherein
the plurality of dielectric layers comprises 0.03 to 3 parts by mass of Sn.

(4) The multilayer ceramic capacitor according to (2), wherein
R2 is greater than or equal to 200000 Ω.

(5) The multilayer ceramic capacitor according to (2), wherein
an Sn content at the interfaces is greater than an Sn content in middle portions of the plurality of the internal electrodes.

Although embodiments of the present disclosure have been described in detail, the present disclosure is not limited to the embodiments described above, and may be changed or varied in various manners without departing from the spirit and scope of the present disclosure. The components described in the above embodiments may be entirely or partially combined as appropriate unless any contradiction arises.

### REFERENCE SIGNS

1 capacitor body
3, 4 external electrode
5 dielectric layer
6 interface
7 internal electrode
9 grain boundary
11 crystal grain of perovskite compound containing Ba and Ti
11a core
11b shell
20a thermostatic chamber
20c impedance measurement device
31 ceramic green sheet
33 internal electrode pattern
35 ceramic pattern
39 stack

1. A multilayer ceramic capacitor, comprising:
a stack including a plurality of dielectric layers stacked on one another and a plurality of internal electrodes located along interfaces between the plurality of dielectric layers; and
a plurality of external electrodes located on outer surfaces of the stack and electrically connected to the plurality of internal electrodes,
wherein the plurality of dielectric layers comprises, as a main component, a perovskite compound containing Ba and Ti, Ba is partially optionally substituted with Ca, and Ti is partially optionally substituted with Zr, and
a sum of resistance values of the main component and other components in the plurality of dielectric layers measured with an alternating current impedance method is greater than or equal to 1 MΩ.

2. The multilayer ceramic capacitor according to claim 1, wherein
the plurality of dielectric layers includes four constituents including cores being center portions of crystal grains of the main component and the other components, shells being outer peripheries of the crystal grains, grain boundaries, and interfaces between the plurality of internal electrodes and the plurality of dielectric layers, and the plurality of dielectric layers is represented with an equivalent circuit model in which each of the constituents is represented by a parallel circuit including a resistance R and a capacitance C and the constituents are connected in series to one another, and
a sum of R1, R2, R3, and R4 is greater than or equal to 1 MΩ, where R1 is a resistance value of the cores, R2 is a resistance value of the shells, R3 is a resistance value of the grain boundaries, and R4 is a resistance value of the interfaces measured with the alternating current impedance method.

3. The multilayer ceramic capacitor according to claim 1, wherein the plurality of dielectric layers comprises 0.03 to 3 parts by mass of Sn.

4. The multilayer ceramic capacitor according to claim 2, wherein R2 is greater than or equal to 200000 Ω.

5. The multilayer ceramic capacitor according to claim 2, wherein an Sn content at the interfaces is greater than an Sn content in middle portions of the plurality of the internal electrodes.
